(19) United States
(12) Patent Application Publication
(10) Pub. No.: US 2015/0180385 A1
(43) Pub. Date: Jun. 25, 2015

(54) DRIVING SIGNAL GENERATING APPARATUS, AND SYSTEM AND METHOD FOR DRIVING MOTOR USING THE SAME

(71) Applicant: SAMSUNG ELECTRO-MECHANICS CO., LTD., Suwon-Si (KR)

(72) Inventors: Sang Hyun PARK, Suwon-Si (KR); Joo Yul KO, Suwon-Si (KR)

(73) Assignee: SAMSUNG ELECTRO-MECHANICS CO., LTD., Suwon-Si (KR)

(21) Appl. No.: 14/248,131

(22) Filed: Apr. 8, 2014

(30) Foreign Application Priority Data
Dec. 20, 2013 (KR) 10-2013-0160238

(51) Int. Cl. H02P 6/08; H02P 6/18; H02P 6/00

(52) U.S. Cl. CPC H02P 6/08; H02P 6/002; H02P 6/182

(57) ABSTRACT

A system for driving a motor may include a motor apparatus including a rotor and a stator, a driving controller generating a voltage command using a target speed input from the outside or a speed of the rotor, and a driving signal generating apparatus including a plurality of inverters, generating a motor driving signal in response to the voltage command using one of the plurality of inverters, and providing the generated motor driving signal to the motor apparatus.

### CROSS-REFERENCE TO RELATED APPLICATIONS

This application claims the priority of Korean Patent Application No. 10-2013-0160238 filed on Dec. 20, 2013, in the Korean Intellectual Property Office, the disclosure of which is incorporated herein by reference.

### BACKGROUND

The present disclosure relates to a driving signal generating apparatus, and a system and a method for driving a motor using the same.

In accordance with the miniaturization and increasing precision of motor technology, various motors have been developed. For example, since permanent magnet synchronous motors (PMSM) have excellent performance in view of efficiency, noise, and the like, as compared to other motors, such motors have been widely used in fields requiring devices having high performance.

In a scheme for controlling a motor as described above, space vector pulse width modulation (SVPWM) has recently been used to satisfy motor requirements such as high output, efficiency, and the like. Space vector pulse width modulation (SVPWM) refers to a pulse width modulation scheme in which a three-phase command voltage is expressed by one space vector in a complex number space and is modulated.

Since space vector pulse width modulation (SVPWM), as described above, has good voltage efficiency, it may generate the highest output in response to a given direct current (DC) voltage. However, since the SVPWM needs to perform many operations, it may consume a relatively large amount of current.

An example of another scheme of controlling a motor includes sinusoidal pulse width modulation (SPWM), in which a command voltage of each phase is compared with a triangular carrier wave in real time to determine an On/Off state of a switch of each phase to thereby modulate the voltage.

Since SPWM has a relatively simply operation, it may consume a relatively small amount of current, as compared to SVPWM. However, since the SPWM may generate an output having a level lower than that of the SVPWM, it may not be suitable for high speed operations.

### SUMMARY

An exemplary embodiment in the present disclosure may provide a driving signal generating apparatus capable of reducing power consumed in an unnecessary operation by selecting one of the plurality of inverters according to a speed of a motor, and a system and a method for driving a motor using the same.

According to an exemplary embodiment in the present disclosure, a system for driving a motor may include: a motor apparatus including a rotor and a stator; a driving controller generating a voltage command using a target speed input from the outside or a speed of the rotor; and a driving signal generating apparatus including a plurality of inverters, generating a motor driving signal in response to the voltage command using one of the plurality of inverters, and providing the generated motor driving signal to the motor apparatus.

The driving signal generating apparatus may generate the motor driving signal using one of the plurality of inverters according to the speed of the rotor.

The driving signal generating apparatus may further include a selection controlling unit selecting one of the plurality of inverters according to a predetermined requirement.

The selection controlling unit may select one of the plurality of inverters according to the speed of the rotor.

The plurality of inverters may include at least one of a first inverter generating the motor driving signal using a triangular wave and the voltage command and a second inverter generating the motor driving signal using a space vector pulse width modulation.

The selection controlling unit may select the first inverter to enable the first inverter to generate the motor driving signal in a case in which the speed of the rotor is less than a preset speed.

The selection controlling unit may select the second inverter to enable the second inverter to generate the motor driving signal in a case in which the speed of the rotor is equal to or greater than a preset speed.

The driving controller may estimate the speed of the rotor using back electromotive force generated by the motor apparatus.

The driving controller may include a sensor detecting a rotational angle and a position of the rotor and may calculate the speed of the rotor using the rotational angle and the position of the rotor.

The sensor may be a resolver sensor detecting the rotational angle and position of the rotor.

According to an exemplary embodiment in the present disclosure, a method for driving a motor may include: generating a voltage command using a target speed input from the outside or a speed of a rotor; generating and outputting a motor driving signal using a triangular wave and the voltage command; estimating the speed of the rotor; and generating and outputting the motor driving signal using a space vector pulse width modulation when the speed of the rotor reaches a preset speed.

In the estimating of the speed of the rotor, the speed of the rotor may be estimated using back electromotive force generated by a motor apparatus.

According to an exemplary embodiment in the present disclosure, a driving signal generating apparatus may include: a plurality of inverters generating a motor driving signal in response to a voltage command; and a selection controlling unit selecting one of the plurality of inverters according to a predetermined requirement, providing the voltage command to the selected inverter, and outputting the motor driving signal generated in response to the provided voltage command.

The selection controlling unit may select one of the plurality of inverters according to the speed of the rotor.

The plurality of inverters may include at least one of a first inverter generating the motor driving signal using a triangular wave and the voltage command and a second inverter generating the motor driving signal using a space vector pulse width modulation.

The selection controlling unit may select the first inverter to enable the first inverter to generate the motor driving signal in a case in which the speed of the rotor is less than a preset speed.

The selection controlling unit may select the second inverter to enable the second inverter to generate the motor driving signal in a case in which the speed of the rotor is equal to or greater than the preset speed.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration diagram illustrating a system for driving a motor according to an exemplary embodiment of the present disclosure;

FIG. 2 is a configuration diagram illustrating an example of a driving signal generating apparatus according to an embodiment of the present disclosure;

FIG. 3 is a configuration diagram illustrating an example of a driving controller shown in FIG. 1;

FIG. 4 is a graph illustrating a motor driving signal generated using a triangular wave;

FIG. 5 is a graph illustrating a motor driving signal generated using a pulse width modulation; and

FIG. 6 is a flow chart illustrating an example of a method for driving a motor according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

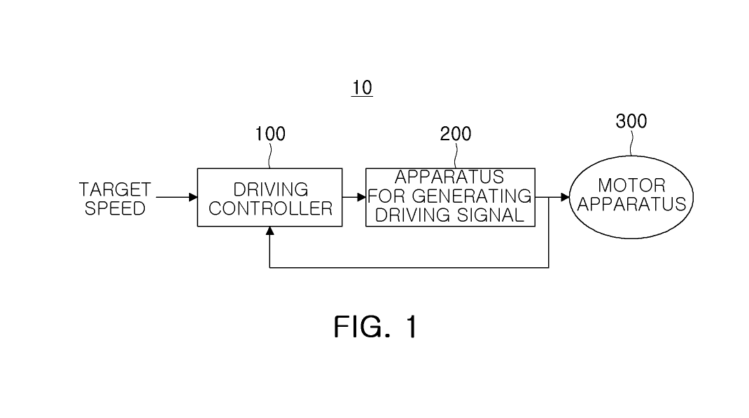

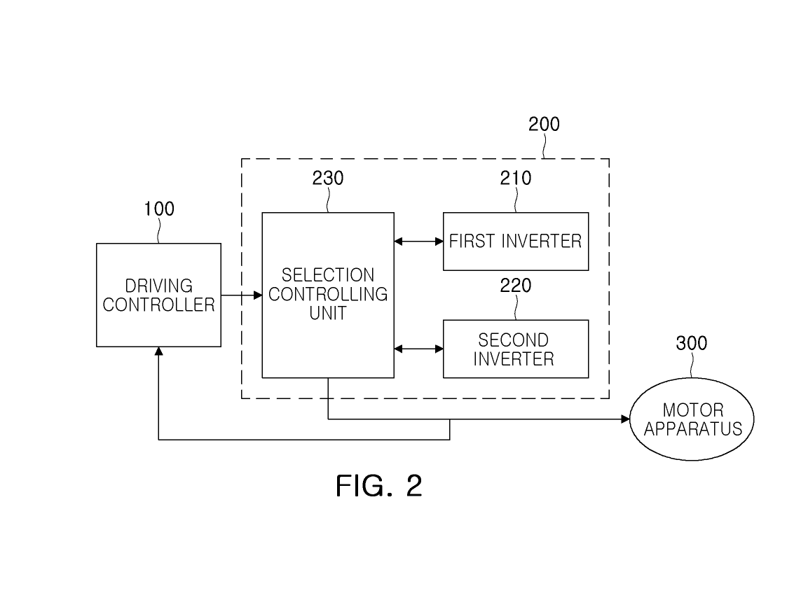

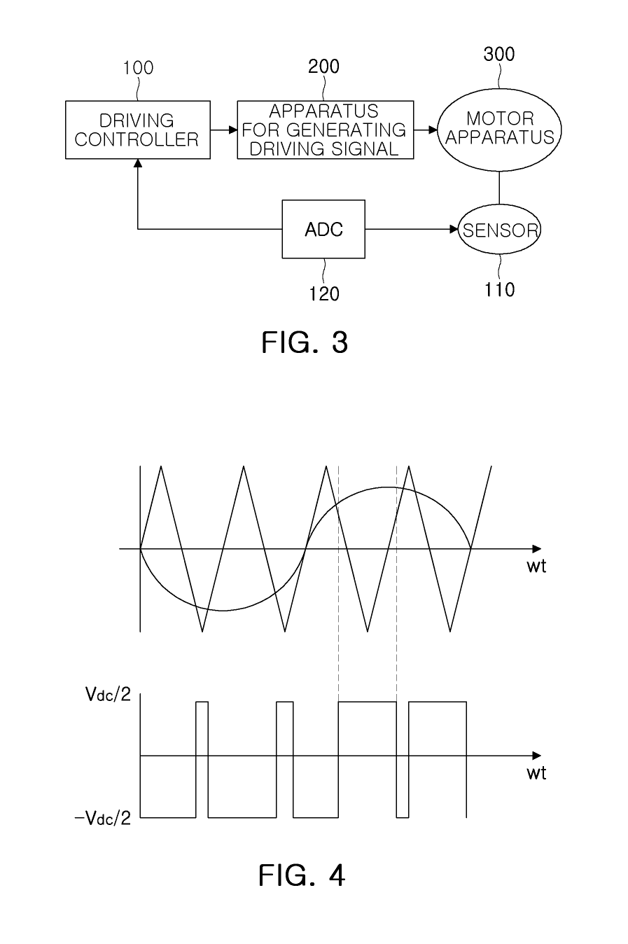

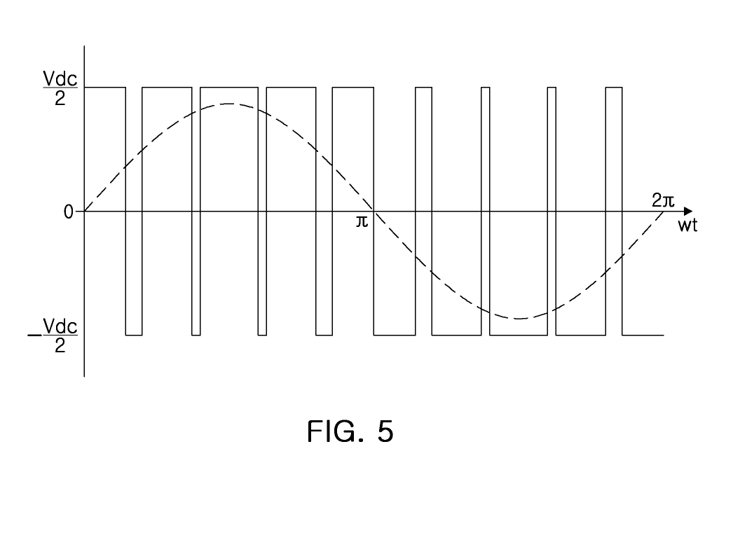

FIG. 1 is a configuration diagram illustrating a system for driving a motor according to an exemplary embodiment of the present disclosure. FIG. 2 is a configuration diagram illustrating an example of a driving signal generating apparatus according to an embodiment of the present disclosure. FIG. 3 is a configuration diagram illustrating an example of a driving controller shown in FIG. 1. FIG. 4 is a graph illustrating a motor driving signal generated using a triangular wave. FIG. 5 is a graph illustrating a motor driving signal generated using a pulse width modulation.

Referring to FIG. 1, a system 10 for driving a motor according to an exemplary embodiment of the present disclosure may include a driving controller 100, an apparatus 200 for generating a driving signal (hereinafter, referred to as “a driving signal generating apparatus 200”), and a motor apparatus 300.

The driving controller 100 may generate a voltage command using a target speed input from the outside or a speed of a rotor of the motor apparatus 300, and may output the voltage command to the driving signal generating apparatus 200.

According to an exemplary embodiment of the present disclosure, although not shown in the drawings, the driving controller 100 may include a speed controlling unit outputting a current command using the target speed or an estimated speed to generate the voltage command, a current controlling unit outputting the voltage command using the current command, a coordinate converting unit converting the voltage command into a voltage command of a fixed coordinate system or converting a motor driving signal into a synchronous coordinate system, and a speed and position estimating unit estimating a speed or position of the rotor of the motor apparatus 300.

According to an exemplary embodiment of the present disclosure, the driving controller 100 may estimate the speed of the rotor using the motor driving signal supplied to the motor apparatus 300.

According to another exemplary embodiment of the present disclosure, as shown in FIG. 3, the driving controller 100 may further include a sensor 110 detecting a rotational angle and the position of the rotor and a converter 120 converting a signal output from the sensor into a digital value.

Here, the sensor 110 may detect the rotational angle and the position of the rotor of the motor apparatus 300 and the driving controller 100 may calculate the speed of the rotor using the rotational angle and the position thereof detected by the sensor 110.

Here, the sensor 110 detecting the rotational angle and the position of the rotor of the motor apparatus 300 may be a resolver sensor. In this case, the converter 120 may be a resolver digital converter (RDC).

The driving signal generating apparatus 200 may generate the motor driving signal in response to the voltage command, provided from the driving controller 100.

Here, the driving signal generating apparatus 200 may include a plurality of inverters 210 and 220 generating the motor driving signal in response to the voltage command by using different schemes.

In addition, the driving signal generating apparatus 200 may generate the motor driving signal using one of the plurality of inverters 210 and 220 according to a predetermined requirement and may supply the motor driving signal to the motor apparatus 300.

According to an exemplary embodiment of the present disclosure, the driving signal generating apparatus 200 may generate the motor driving signal using one of the plurality of inverters 210 and 220 according to a speed of the rotor of the motor apparatus 300.

Referring to FIG. 2, the driving signal generating apparatus 200 according to an exemplary embodiment of the present disclosure may include the first inverter 210, the second inverter 220, and a selection controlling unit 230.

Here, the first inverter 210 and the second inverter 220 may generate the motor driving signal using different schemes.

According to an exemplary embodiment of the present disclosure, the first inverter 210 may generate the motor driving signal using a sinusoidal pulse width modulation (SPWM) (see FIGS. 4 and 5) in which the motor driving signal is generated using a triangular wave and the voltage command. In addition, the second inverter 220 may generate the motor driving signal using a space vector pulse width modulation (SVPWM).

The selection controlling unit 230 may select one of the plurality of inverters 210 and 220 according a predetermined requirement to allow the selected inverter to generate the motor driving signal to be output to the motor apparatus 300.

According to an exemplary embodiment of the present disclosure, the selection controlling unit 230 may select one of the plurality of inverters 210 and 220 according to the speed of the rotor of the motor apparatus 300.

For example, the selection controlling unit 230 may select the first inverter 210 in a case in which the speed of the rotor is less than a predetermined speed to thereby output the motor driving signal generated using the sinusoidal pulse width modulation (SPWM) to the motor apparatus 300.

In addition, the selection controlling unit 230 may select the second inverter 220 in a case in which the speed of the rotor is equal to or greater than the predetermined speed to thereby output the motor driving signal generated using the space vector pulse width modulation (SVPWM) to the motor apparatus 300.

That is, the selection controlling unit 230 may select the first inverter 210 to enable the first inverter 210 to generate the motor driving signal in a low speed section and select the second inverter 220 to enable the second inverter 220 to generate the motor driving signal in a high speed section.

By way of example, the selection controlling unit 230 may perform control to generate the motor driving signal using the sinusoidal pulse width modulation (SPWM) in a case in which the motor apparatus 300 is operated at a low speed and may perform control to generate the motor driving signal using the space vector pulse width modulation (SVPWM) in a case in which the motor apparatus 300 is operated at a high speed.

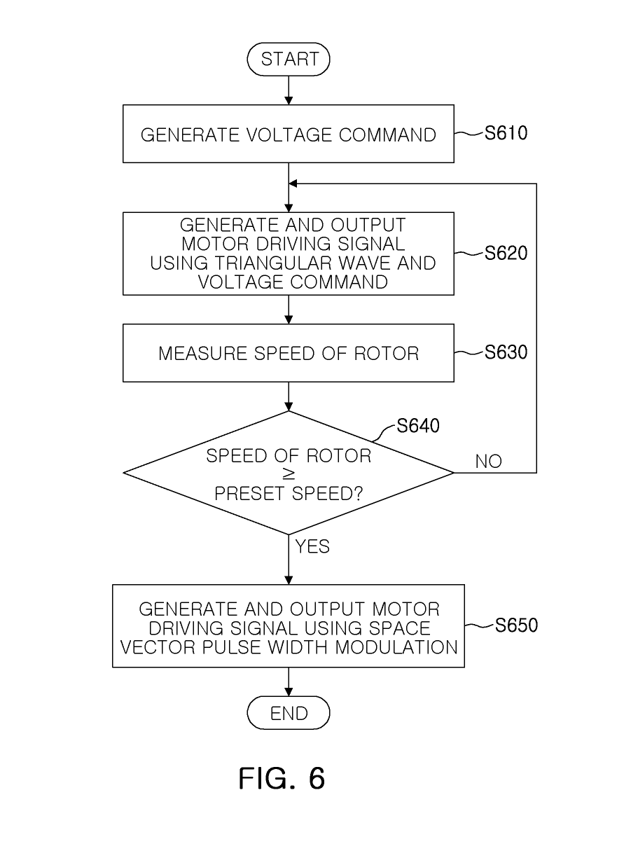

FIG. 6 is a flow chart illustrating an example of a method for driving a motor according to an exemplary embodiment of the present disclosure.

Since the example of the method for driving the motor shown in FIG. 6 is performed in the system 10 for driving the motor described above with reference to FIGS. 1 through 5, an overlapped descriptions of contents the same as or corresponding to the above-mentioned contents will be omitted.

Referring to FIG. 6, the system 10 for driving the motor may generate the voltage command using the target speed input from the outside or the speed of the rotor (S610).

Next, the system 10 for driving the motor may generate the motor driving signal using the triangular wave and the generated voltage command (S620).

Next, the system 10 for driving the motor may estimate the speed of the rotor (S630), and generate and output the motor driving signal using the space vector pulse width modulation (SVPWM) (S650) when the speed of the rotor reaches a preset speed (S640).

According to an exemplary embodiment of the present disclosure, in the estimating of the speed of the rotor (S630), the speed of the rotor may be estimated by using the motor driving signal. Here, the motor driving signal may be a three-phase current and the system 10 for driving the motor may estimate the speed of the rotor using back electromotive force of the three-phase current.

As set forth above, according to exemplary embodiments of the present disclosure, a plurality of inverters may be provided and one of the plurality of inverters may be selected according to a speed of a motor, whereby power consumed in an unnecessary operation may be reduced.

While exemplary embodiments have been shown and described above, it will be apparent to those skilled in the art that modifications and variations could be made without departing from the spirit and scope of the present disclosure as defined by the appended claims.

What is claimed is:

1. A system for driving a motor, comprising:
a motor apparatus including a rotor and a stator;
a driving controller configured to generate a voltage command using a target speed input from the outside or a speed of the rotor; and
a driving signal generating apparatus including a plurality of inverters, configured to generate a motor driving signal in response to the voltage command using one of the plurality of inverters, and provide the generated motor driving signal to the motor apparatus.

2. The system of claim 1, wherein the driving signal generating apparatus generates the motor driving signal using one of the plurality of inverters according to the speed of the rotor.

3. The system of claim 1, wherein the driving signal generating apparatus further includes a selection controlling unit selecting one of the plurality of inverters according to a predetermined requirement.

4. The system of claim 3, wherein the selection controlling unit selects one of the plurality of inverters according to the speed of the rotor.

5. The system of claim 1, wherein the plurality of inverters includes at least one of a first inverter generating the motor driving signal using a triangular wave and the voltage command and a second inverter generating the motor driving signal using a space vector pulse width modulation.

6. The system of claim 5, wherein the selection controlling unit selects the first inverter to enable the first inverter to generate the motor driving signal in a case in which the speed of the rotor is less than a preset speed.

7. The system of claim 5, wherein the selection controlling unit selects the second inverter to enable the second inverter to generate the motor driving signal in a case in which the speed of the rotor is equal to or greater than a preset speed.

8. The system of claim 1, wherein the driving controller estimates the speed of the rotor using back electromotive force generated by the motor apparatus.

9. The system of claim 1, wherein the driving controller includes a sensor detecting a rotational angle and a position of the rotor and calculates the speed of the rotor using the rotational angle and the position of the rotor.

10. The system of claim 9, wherein the sensor is a resolver sensor detecting the rotational angle and position of the rotor.

11. A method for driving a motor, comprising:
generating a voltage command using a target speed input from the outside or a speed of a rotor;
generating and outputting a motor driving signal using a triangular wave and the voltage command;
estimating the speed of the rotor; and
generating and outputting the motor driving signal using a space vector pulse width modulation when the speed of the rotor reaches a preset speed.

12. The method of claim 11, wherein in the estimating of the speed of the rotor, the speed of the rotor is estimated using back electromotive force generated by a motor apparatus.

13. A driving signal generating apparatus, comprising:
a plurality of inverters configured to generate a motor driving signal in response to a voltage command; and
a selection controlling unit configured to select one of the plurality of inverters according to a predetermined requirement, provide the voltage command to the selected inverter, and output the motor driving signal generated in response to the provided voltage command.

14. The driving signal generating apparatus of claim 13, wherein the selection controlling unit selects one of the plurality of inverters according to the speed of the rotor.

15. The driving signal generating apparatus of claim 13, wherein the plurality of inverters include at least one of a first inverter generating the motor driving signal using a triangular wave and the voltage command and a second inverter generating the motor driving signal using a space vector pulse width modulation.

16. The driving signal generating apparatus of claim 15, wherein the selection controlling unit selects the first inverter to enable the first inverter to generate the motor driving signal in a case in which the speed of the rotor is less than a preset speed.

17. The driving signal generating apparatus of claim 16, wherein the selection controlling unit selects the second inverter to enable the second inverter to generate the motor driving signal in a case in which the speed of the rotor is equal to or greater than the preset speed.
